(19) United States
(12) Patent Application Publication
(10) Pub. No.: US 2023/0406174 A1
(43) Pub. Date: Dec. 21, 2023

(54) VENTILATION ASSEMBLY FOR SEAT ASSEMBLY

(71) Applicant: Lear Corporation, Southfield, MI (US)

(72) Inventors: Sam Blair, Troy, MI (US); David Abdella, Royal Oak, MI (US); Joshua Hallock, 31954 Dover Ave., MI (US); Ashley Baisch, Washington Twp, MI (US)

(21) Appl. No.: 17/841,745

(22) Filed: Jun. 16, 2022

(51) Int. Cl. B60N 2/56

(52) U.S. Cl. CPC B60N 2/5642

(57) ABSTRACT

Seat assemblies and subassemblies are disclosed. For example, a ventilation subassembly may be disclosed. The subassembly may include a trim cover with a ventilation bag or membrane fixed thereto such as by stitching or welding. The ventilation bag or membrane may be disposed adjacent to the trim cover and extend from the trim cover through one or more additional layer to a carrier such that it is configured to receive a fluid flow from a blower for ventilating an occupant adjacent to the trim cover.

### TECHNICAL FIELD

The present disclosure relates to ventilation assemblies such as for a vehicle seat assembly.

### BACKGROUND

Seat assemblies and subassemblies are disclosed in U.S. Pat. No. 7,874,616 which issued to Lear Corporation on Jan. 25, 2011.

### SUMMARY

A ventilation assembly for a seat is disclosed. The ventilation assembly include a trim cover, a ventilation bag, and a spacer fabric. The trim cover is configured to contact an occupant and provide ventilation from a fluid flow, during operation and when assembled in a seat. The ventilation bag defines a cavity and a channel that is in fluid communication with the cavity. A spacer is disposed in the cavity. The channel is configured to engage or connect with a blower through one or more additional layers. The ventilation bag is fixed to the trim cover and the channel is opposite the trim cover such that a fluid flow may travel from the ventilation bag to the trim cover.

The ventilation bag may be sewn or welded to the trim cover. The ventilation bag may also be fixed to the trim cover at least partially along an outer periphery of, for example, a face of a seat assembly. The one or more additional layers may include a substrate configured to support a blower. The one or more additional layers may include a foamless mesh. The ventilation assembly may further comprise a blower supported by the substrate. The ventilation bag may include a first sheet fixedly sealed to a second sheet to define the cavity and channel. The first sheet may be adjacent to the trim cover and the second sheet may be opposite the trim cover. The one or more additional layers may not be foamless or not include a foam cushion.

A vehicle seat is disclosed. The seat assembly may include a seat frame and the ventilation assembly as described herein supported thereto.

A seat subassembly is also disclosed. The subassembly includes a trim cover, a carrier, a first sheet, a second sheet, a spacer and one or more additional layers. The trim cover includes an exposed surface and an unexposed surface opposite the exposed surface. The trim cover is configured to provide ventilation to an occupant adjacent to the exposed surface when a fluid flow is received at the unexposed surface. The carrier defines an orifice and be configured to support a blower such that the orifice may receive a fluid flow from the blower. The first sheet is sealed to the second sheet such that the first and second sheets define a cavity including a channel. The spacer is disposed in the cavity. The first and second sheets are disposed between the trim cover and the carrier. The first sheet is fixed to the trim cover such that a fluid flow received in the cavity is provided to the trim cover. The channel is configured to receive a fluid flow from the blower through the orifice of the carrier. The one or more additional layers are disposed between the second sheet and the carrier such that the channel may provide a passage through the one or more additional layers from blower. Thus, ventilation is provided from the blower, through the channel to the cavity, and then through the trim cover to, for example, an occupant.

The first sheet may be fixed to the trim cover by being sewn or welded. The spacer may be disposed between the first and second sheets.

A seat assembly comprising a seat frame and the seat subassembly as described herein is also disclosed. The seat frame may support the seat subassembly.

A ventilation assembly for a seat is also disclosed. The assembly includes a trim cover, a carrier, a cushion and a membrane. The carrier defines a first orifice configured to receive a fluid flow from a blower during operation. The blower is supported by the carrier. The cushion is disposed between the trim cover and the carrier and adjacent to the carrier. The cushion defines a second orifice. The membrane is fixed to the trim cover and disposed between the trim cover and the carrier. The membrane extends through the second orifice of the cushion to the first orifice of the carrier. Thus, ventilation is provided from a blower along the member to the trim cover and an occupant adjacent to the trim cover during operation.

The membrane may be fixed to the trim cover along an outer periphery. The membrane may be fixed to the trim cover by being sewn or welded. The ventilation assembly of claim 17, wherein the membrane is sealed by being sewn. In a refinement, the membrane may be fixed to the trim cover by being welded. In another refinement, the membrane may be fixed to the trim cover by being sewn.

A vehicle seat comprising a seat frame and the ventilation assembly described herein is disclosed. The seat frame may support the ventilation assembly.

### BRIEF DESCRIPTION OF THE DRAWINGS

FIG. 1 is perspective view of a seat assembly.

FIG. 2 is cross-sectional schematic of an embodiment of a ventilation assembly.

FIG. 3 is cross-sectional schematic of another embodiment of a ventilation assembly.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for given purpose implies the mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

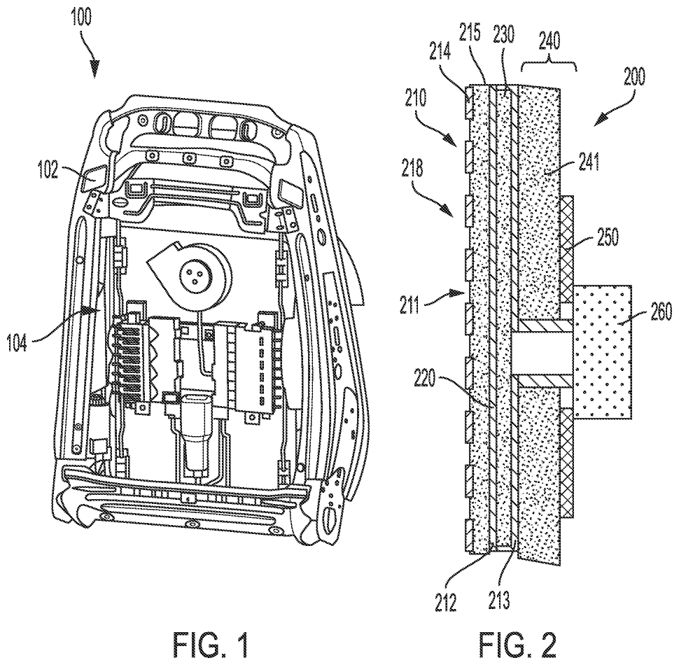

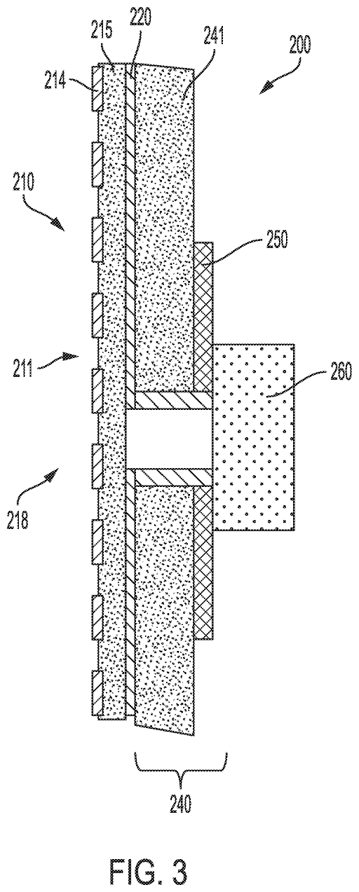

Referring to FIG. 1, a seat assembly 100 such as a vehicle seat assembly is disclosed. The seat assembly 100 includes a seat frame 102 and a subassembly 104 such as a ventilation subassembly. The subassembly 104 may be supported by the seat frame 102. Referring to FIGS. 2-3, the subassembly 200 includes a trim cover 210 fixed to a membrane 220, one or more additional layers 240 such as a cushion, and/or a substrate 250.

The trim cover 210 is configured to be adjacent to a seat occupant, i.e., the trim cover may include the outermost layer or include a surface that is the outer most surface. The trim cover 210 may cover the remaining components of the seat assemble 100 and be the primary contact surface with the occupant. The trim cover 210 may be configured to provide ventilation to the occupant while seated and during operation. For example, the trim cover 210 may include one or more perforations 211 and/or be permeable to a fluid such as air. The trim cover 210 may include a first surface 212 (e.g., exposed surface) and a second surface 213 (e.g., unexposed surface) opposite the first surface 212. The first surface 212 may be the surface of a fabric, faux leather, or leather. For instance, the fabric or faux leather may be cotton, polyester, polyurethane, nylon, or any other suitable fabric. In a variation, the fabric or faux leather may be a polyester or polyurethane. The trim cover 210 may also include one or more layers such as an outer layer 214 and an inner layer 215. For example, the outer layer 214 may be a polyurethane faux leather or a polyester fabric and inner layer 215 may be a spacer fabric or a thin polyurethane foam cushion (e.g., 0.05 to 5 mm, or more preferably 0.1 to 3 mm, or even more preferably 0.25 to 1.25 mm). The inner layer 215 may be permeable to a fluid flow such as air but the outer layer 214 may be made of an impermeable material such as a faux leather or leather. If the outer layer 214 is an impermeable material, it may be perforated such that it can provide ventilation to an adjacent occupant when it receives a fluid flow from the inner layer 215.

The trim cover 210 may be fixed and/or sealed to the membrane 220 such that the membrane 220 cannot be removed without damaging the trim cover 210, membrane 220 or fixing/sealing medium (e.g., sewing or welding). In a variation, the trim cover 210 and membrane 220 may at least partially be fixed and/or sealed along or proximate to an outer periphery or perimeter of, for example, a seat face 218. In a variation, trim cover 210 may be fixed/sealed to the membrane 220 such that it is impermeable or does not leak a fluid flow such as air at the connection interface. In a refinement, fixed may refer to an immutably connection such that it excludes a peel and stick adhesive that may be easily disconnected without damaging the materials. The membrane 220 may be disposed between the trim cover 210 and the substrate 250. In a variation, the membrane 220 may be adjacent to the trim cover 210. The membrane 220 may also be disposed adjacent to one or more additional layers 240. The one or more additional layers 240 may be disposed between the membrane 220 and the substrate 250. Said differently, the assembly may include a trim cover 210 connected to and adjacent the membrane 220, which is adjacent the one or more additional layers that are opposite the trim cover 210.

In a refinement, the membrane 220 may form a ventilation bag 222 defining a cavity, as shown in FIG. 2. In yet another refinement, the membrane 220 and trim cover 210 may work together to form a cavity as shown in FIG. 3. The cavity may include a channel. Alternatively, the membrane 220 or ventilation bag may further define a channel in fluid communication with the cavity. Thus, the channel is disposed opposite the trim cover and extends away from the trim cover toward and proximate to an outlet of a blower 260. The channel is configured to receive a fluid flow from the blower 260. For example, in a variation, the channel may be disposed and sealed around an outlet of the blower 260 such as by a ring gasket or ring snap. Alternatively, the channel may be disposed in the outlet or engage the substrate 250.

The membrane 220 is made of an impermeable fabric that does not allow a fluid flow such as air to transfer through the fabric. For example, the membrane 220 may be plastic and/or fabric sheets such as polyethylene, polyurethane, thermoplastic polyurethane, and/or felt such as Tyvek®. The ventilation bag may have a spacer 230 disposed in the cavity defined by the ventilation bag. The spacer 230 may be any suitable structure that resist crushing that would impede a fluid flow permeating through it. For example, the spacer 230 may be a spacer fabric that is permeable to air. The ventilation bag may also be formed from one or more sheets.

For example, the membrane 220 may be formed from a first sheet 224 and a second sheet 225 that are fixed to one another to define the cavity. The first and second sheets 224, 225 may be fixed such that they form a seal. For example, the first and second sheets 224, 225 may be fixed to one another by stitching, heat-staking, ultrasonic staking, hot-plate welding, heat swaging, cold pressing, or the like such that they do not allow a fluid flow to escape except through one or more designated apertures. In a variation, the first sheet 224 may be permeable to a fluid flow such as air. Thus, the ventilation bag 222 may be configured to provide fluid communication the trim cover 210. In a refinement, the first sheet 224 may be disposed adjacent to the trim cover 210 and the second sheet 225 may be disposed opposite the trim cover 210 such that the first sheet 224 is disposed between the trim cover 210 and the second sheet 225.

The one or more additional layers 240 may include a cushion or comfort material 241. The cushion or comfort material 241 can may provide comfort to an occupant while seated. For example, the cushion or comfort material may be a foam. In a variation, the cushion or comfort material 241 may be a foamless mesh. In a refinement, the ventilation assembly 200 and/or seat assembly 100 may be foamless. In a refinement, the ventilation assembly may be foamless such that it does not include a foam cushion. Said differently, seat assembly may be foamless.

Foamless may refer to one or more stacked layers of a non-foam material. Each layer may be formed from a knitted monofilament textile material. An example of the material is a polyester, such as polyethylene terephthalate. The material may also be formed from a recycled material to reduce material costs, and to reduce waste. The material may be non-woven, woven, and/or knitted to provide structure, while also spaced out to provide porosity, ventilation, and compliancy. The non-foam material may be made of a monofilament textile. For example, additional details of a non-foam or foamless material can be found in the application identified by Ser. No. 17/218,663 filed on Mar. 31, 2021, the entirety of which is hereby incorporated by reference.

In a variation, the non-foam or foamless material may be a non-woven thermoplastic resin mesh. The mesh may be formed by extruding a pressurized molten thermoplastic resin from an extruder through an extrusion die. The extrusion die may include a plurality of outlet ports or nozzles to dispense a plurality of strands of the molten thermoplastic resin. The strands are dispensed into a fluid chamber having a fluid (e.g., water) to resist and cool the strands. The fluid resists the flow of the strands causing the strands to buckle, loop, and/or intersect with adjacent strands. The solidified and intertwined strands form a unitary non-woven thermoplastic mesh cushion. For example, additional details of this process are disclosed in the application identified by Ser. No. 17/741,639 filed on May 11, 2022, the entirety of which is hereby incorporated by reference.

The one or more additional layers 240 may define an orifice 241 such that the membrane 220 may pass through the one or more additional layers 240 from the trim cover 210 to the blower 260 for receiving a fluid flow from the blower 260 during operation.

The one or more additional layers 240 may also include the substrate 250 may support multiple components such as the blower 260, a pump, electrical circuitry, the ventilation assembly 200, and/or a massaging/bladder assembly, in which case it may be referred to as a carrier. The substrate 250 may be suspended such as by a suspension system (e.g., suspension wires) to the seat frame 102 of a seat assembly 100. The substrate 250 may be a rigid board such a plastic board. The substrate 250 or carrier may define an orifice such that a fluid flow can be received through the orifice from the blower 260 during operation. Alternatively, the blower 260 may be directly connected to the ventilation bag.

The blower 260 may include a motor in mechanical communication with a fan such that it is configured to provide a fluid flow during operation. The blower 260 may include an inlet for receiving a fluid such as air and an outlet for delivering a fluid flow during operation. Thus, in one or more embodiments, the ventilation assembly 200 may be configured to receive or deliver a fluid flow from or to the blower 260 such that the fluid flow may travel along the membrane 220 or through the ventilation bag formed by the membrane 220 to the trim cover 210 and through the trim cover 210 or vice versa to provide ventilation to a seated occupant during operation and when assembled in a seat assembly. In other words, the blower may be configured to provide an air flow to the occupant or draw an air flow from the occupant to provide ventilation (i.e., the blower may be configured to pull or push air).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A ventilation assembly for a seat comprising:
a trim cover configured to contact an occupant and provide ventilation from a fluid flow when assembled in a seat and during operation;
a ventilation bag (i) defining a cavity and a channel in fluid communication with the cavity and disposed opposite the trim cover, the channel being configured to connect with a blower through one or more additional layers and (ii) fixed to the trim cover such that a fluid flow travels from the ventilation bag to the trim cover or vice versa; and
a spacer fabric disposed in the cavity.

2. The ventilation assembly of claim 1, wherein the ventilation bag is sewn or welded to the trim cover.

3. The ventilation assembly of claim 1, wherein the ventilation bag is fixed to the trim cover at least partially along an outer periphery.

4. The ventilation assembly of claim 1, wherein the one or more additional layers comprise a substrate configured to support a blower.

5. The ventilation assembly of claim 4, wherein the one or more additional layers comprise a foamless mesh.

6. The ventilation assembly of claim 5, further comprising the blower supported by the substrate.

7. The ventilation assembly of claim 1, wherein the ventilation bag comprises a first sheet adjacent to the trim cover and a second sheet fixedly sealed to the first sheet and opposite the trim cover such that the first and second sheets define the cavity and the channel.

8. The ventilation assembly of claim 1, wherein the one or more additional layers do not include a foam cushion.

9. A seat assembly comprising the ventilation assembly of claim 3, wherein the outer periphery is the outer periphery of a face of the seat assembly.

10. A vehicle seat comprising the ventilation assembly of claim 1 and a seat frame supporting the ventilation assembly.

11. A seat subassembly comprising:
a trim cover having an exposed surface and an unexposed surface opposite the exposed surface, the trim cover configured to provide ventilation to an occupant adjacent to the exposed surface when a fluid flow is received at the unexposed surface;
a carrier configured to support a blower, the carrier defining an orifice for receiving the fluid flow from the blower;
a first sheet fixed to the trim cover and between the trim cover and the carrier;
a second sheet between the first sheet and the carrier, the second sheet sealed to the first sheet such that the first and second sheets define a cavity including a channel, the channel configured to receive a fluid flow from the blower through the orifice;
a spacer disposed in the cavity; and
one or more additional layers disposed between the second sheet and the carrier such that the channel provides a passage through the one or more additional layers wherein ventilation is provided to or from the blower through the cavity and to or from the occupant adjacent to the trim cover.

12. The seat subassembly of claim 11, wherein the first sheet is fixed to the trim cover by being sewn or welded.

13. The seat subassembly of claim 11, wherein the spacer is disposed between the first and second sheets.

14. A seat assembly comprising a seat frame and the seat subassembly of claim 11 supported by the seat frame.

15. A ventilation assembly for a seat comprising:
a trim cover;
a carrier configured to support a blower, the carrier defining a first orifice configured to receive a fluid flow from the blower during operation;
a cushion disposed between the trim cover and the carrier, the cushion adjacent to the carrier and defining a second orifice; and
a membrane disposed between the cushion and the trim cover and extending through the second orifice, the membrane fixed to the trim cover such that the fluid flow is received or delivered through the first orifice to the trim cover and provides ventilation through the trim cover to an occupant adjacent to the trim cover during operation.

16. The ventilation assembly of claim 15, wherein the membrane is fixed to the trim cover along an outer periphery.

17. The ventilation assembly of claim 15, wherein the membrane is sewn or welded to the trim cover.

18. The ventilation assembly of claim 17, wherein the membrane is sewn to the trim cover.

19. The ventilation assembly of claim 17, wherein the membrane welded to the trim cover.

20. A vehicle seat comprising a seat frame and the ventilation assembly of claim 15 supported by the seat frame.
